(19) United States
(12) Patent Application Publication
(10) Pub. No.: US 2025/0178173 A1
(43) Pub. Date: Jun. 5, 2025

(54) FORGED HAMMER HEAD WITH SIDE NAIL PULLER

(71) Applicant: Stanley Black & Decker, Inc., New Britain, CT (US)

(72) Inventors: Austin Charles ALLESSIO, New Britain, CT (US); Jose Francisco MENDEZ CRUZ, Cuautlancingo (MX); Christopher Allen Vogado CATE, Durham, NC (US)

(21) Appl. No.: 18/529,684

(22) Filed: Dec. 5, 2023

(51) Int. Cl. B25D 1/04; B21K 5/14; B25D 1/06

(52) U.S. Cl. CPC B25D 1/045; B21K 5/14; B25D 1/06

(57) ABSTRACT

A forged hammer head formed in a forging process comprises a forged hammer face at one end of the head; a forged hammer claw at an end of the head opposite the face; and a forged side nail puller disposed between the face and the claw. A method for forming a hammer head comprises sequentially placing a blank in a series of cooperating forging dies, and sequentially shaping the blank in the forging dies into a hammer head, a hammer claw, a hammer face and a side nail puller disposed between the face and the claw. The side nail puller is configured to engage and pull a nail from a workpiece. The side nail puller comprises a side wall and a notch formed in the side wall. A tool parting line of the forging process does not intersect the notch.

### FIELD

The present patent application relates to hammers and side nail pullers for the hammers.

### BACKGROUND

Hammers may be used to both drive nails into a workpiece and remove nails from the workpiece. Hammers generally include a hammer head that is either fixedly secured to or integrally formed with a hammer handle. During use, a strike surface disposed on the head of the hammer is configured to strike against an object, such as a nail or chisel.

Several different tools, including a claw hammer, various pry bars, and other tools, may be used for removing nails from the workpiece. Each tool is suited to specific applications depending on the access to the nail and force required to remove the nail from the workpiece. For example, a nail positioned near the end of a workpiece may be difficult to remove because there may not be enough room at the end of the workpiece for the claw hammer. Further, the leverage of the claw hammer may be insufficient to remove difficult nails, such as long nails in hardwoods. In such a case, a second tool, such as a pry bar, may be used.

Side nail pullers may be provided on some hammers and the side nail pullers may be used to remove (stubborn) nails (from the workpieces) in certain positions that were otherwise difficult or impossible.

Some side nail pullers are generally known.

For example, U.S. Pat. No. 6,923,432 (“the '432 Patent”) discloses a side nail puller mounted on the side of a head of a hammer. The nail puller may be fashioned by casting or forging an opening into the hammer. The side nail puller of the '432 Patent may be manufactured by machining, punching, or other metal removal process. The side nail puller of the '432 Patent may be mechanically attached to the hammer head by welding, brazing, fastening, or other means. The side nail puller of the '432 Patent may be a metallic insert that is either molded or attached to a composite hammer head (e.g., using composite materials such as reinforced plastics or thermoset materials).

Some prior art hammers having a side nail puller may comprise a one-piece hammer in which the entire hammer including the head and the handle are made of the same material (e.g., metal material). The head of this hammer is formed by a forging procedure/process, while the side nail puller of this hammer is formed by a milling procedure after forging the hammer (including the head and the handle). That is, the milling process/procedure is used to open up the nail puller. As is generally known, milling is the process of machining using rotary cutters to remove material by advancing a cutter into a workpiece (e.g., the forged hammer head). The machining may be done by varying directions on one or several axes, cutter head speed, and pressure. For example, the forged hammer head may undergo a milling procedure to form the milled side nail puller on the forged hammer head. The shape of the milled side nail puller is made by removing the material from the hammer head. So, the cost of the forged hammer head with the milled side nail puller may be high as there is material waste during the milling procedure. The milled side nail puller may also be prone to failure along the machined area.

Some prior art hammers having a side nail puller may comprise a one-piece hammer in which the entire hammer including the head and the handle are made of the same material (e.g., metal material). The head of this hammer is formed by a forging procedure/process, while the side nail puller of this hammer is formed by a welding procedure. As is generally known, welding is a metalworking technique/process of fusing metal by melting parts of it. For example, the side nail puller may be welded on the forged hammer head. Welding may rely on flux wires that act as a metallic adhesive after it is melted.

Some prior art hammers having a side nail puller may comprise two-piece hammers in which the head and the handle may made of the same material (e.g., metal material) or may made of different materials (e.g., metal head and wooden handle). In some such hammers, the heads of these hammers may be formed by a forging procedure/process, while the side nail pullers of these hammers may be formed by a welding procedure.

Some prior art hammers having a side nail puller may comprise a two-piece hammer in which the head and the handle may made of different materials (e.g., metal/titanium head and wooden handle). The head of this hammer is formed from a titanium material and the hammer head is formed by a casting procedure/process. That is, this hammer includes a cast titanium head. As is generally known, casting is the process in which metal is heated in a furnace until molten. While in the liquid state, the metal is poured in a die, or mold, to create a component shape. There may be the potential for contamination while the metal is in liquid state. In the cooling state, defects such as interior tears or cracks may develop in the cast side nail puller as the mass of the cast side nail puller cools at different rates.

Some prior art hammers having side nail pullers may comprise two-piece hammers in which their heads and their handles may made of the same material (i.e., titanium material). In some such hammers, the heads and the side nail pullers of these hammers may be formed by a casting procedure/process. Also, the heads and the side nail pullers of these hammers may be formed from titanium material.

Some prior art hammers having a side nail puller may comprise a two-piece hammer in which the head, including the side nail puller, is made from welded sheet metal parts. In some such hammers, the welded sheet metal parts of one such hammer head may be disassembled from an assembled hammer.

The present patent application provides improvements in the side nail pullers provided on the hammers.

### SUMMARY

The present patent application provides hammers and side nail pullers for hammer.

One aspect of the present patent application provides a forged hammer head formed in a forging process. The forged hammer head comprises a forged hammer face at one end of the head, a forged hammer claw at an end of the head opposite the face, and a forged side nail puller disposed between the face and the claw. The side nail puller is configured to engage and pull a nail from a workpiece. The side nail puller comprises a side wall and a notch formed in the side wall. A tool parting line of the forging process does not intersect the notch.

In an aspect, the hammer head may be formed as part of a two-piece hammer. The hammer head may comprise an eye-hole extending therethrough for receiving a hammer handle.

In an aspect, the hammer head may be devoid of any structure between the notch and the eye-hole.

In an aspect, a vestige of the tool parting line may be formed on the hammer head. The vestige may be formed between the notch and a top end of the hammer head.

In an aspect, the hammer head may be formed as part of a one-piece hammer. The hammer head may be integrally formed as part of the same forging process as the hammer handle shaft.

In an aspect, the notch may be perpendicular to the tool parting line.

In an aspect, the forged side nail puller is on one side of the hammer head. The forged hammer head may further comprise a second forged side nail puller that is disposed on an opposing side of the hammer head.

In an aspect, the forged side nail puller may be one of the plurality of forged side nail pullers.

In an aspect, the tool parting line of the forging process is above the notch

Another aspect of the present patent application provides a method for forming a hammer head. The method comprises sequentially placing a blank in a series of cooperating forging dies, and sequentially shaping the blank in the forging dies into a hammer head, a hammer claw, a hammer face, and a side nail puller disposed between the face and the claw. The side nail puller comprises a side wall and a notch formed in the side wall. The hammer head is configured to be coupled to or formed with a handle shaft. The notch extends generally parallel to an axis of elongation for the handle shaft.

In an aspect, the forging dies may comprise at least two die portions. A tool parting line may be formed at an interface of the die portions. The tool parting line may be formed such that the tool parting line does not intersect the notch.

Yet another aspect of the present patent application provides a forged hammer head for a two-piece hammer. The hammer head is formed in a forging process. The hammer head comprises a forged hammer face at one end of the head, a forged hammer claw at an end of the head opposite the face, and a forged side nail puller disposed between the face and the claw. The side nail puller is configured to engage and pull a nail from a workpiece. The side nail puller comprises a side wall and a notch formed in the side wall. The hammer head has an eye-hole extending therethrough for receiving a hammer handle. The hammer head is devoid of any structure between the notch and the eye-hole.

In an aspect, the forged hammer head may be formed in a forging process. A tool parting line of the forging process does not intersect the notch.

In an aspect a vestige of the tool parting line is formed on the hammer head. The vestige may be formed between the notch and a top end of the hammer head.

In an aspect, the notch may be perpendicular to the tool parting line.

In an aspect, the forged side nail puller may be on one side of the hammer head. The forged hammer head may further comprise a second forged side nail puller that is disposed on an opposing side of the hammer head.

In an aspect the forged side nail puller is one of the plurality of forged side nail pullers.

In an aspect, the tool parting line of the forging process is above the notch.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

### BRIEF DESCRIPTION OF THE DRAWINGS

FIG. 1 shows an exemplary hammer according to various embodiments of the present patent application, where the hammer has a forged hammer head, which includes a forged side nail puller disposed between a forged hammer face and a forged hammer claw;

FIG. 2 shows a top perspective view of the forged hammer head of FIG. 1 along with the forged side nail puller;

FIG. 3 shows a cross-sectional view of the forged hammer head of FIG. 1 along with the forged side nail puller;

FIG. 4 shows a front view of the forged hammer head of FIG. 1 along with the forged side nail puller;

FIG. 5 shows a front view of a forged hammer head, according to various embodiments of the present patent application, with a forged side nail puller;

FIG. 6 shows a detailed view of portion A in FIG. 5;

FIG. 7 shows a front view of the forged hammer head of FIG. 5 along with the forged side nail puller and with an exemplary tool parting line being shown;

FIG. 8 shows a rear view of the forged hammer head of FIG. 5 along with a forged rear side nail puller and a forged rear side staple puller;

FIG. 9 shows a detailed view of portion B in FIG. 8;

FIG. 10 shows a rear view of the forged hammer head of FIG. 8 along with the forged rear side nail puller and the forged rear side staple puller, and with an exemplary tool parting line being shown;

FIG. 11 shows a top view of the forged hammer head of FIG. 5;

FIG. 12 shows a detailed view of portion C in FIG. 11;

FIG. 13 shows a bottom view of the forged hammer head of FIG. 5;

FIG. 14 shows a bottom perspective view of two upper forging die halves of a hammer head forging tool, according to various embodiments of the present patent application, with an exemplary tool parting line being shown in one of the two upper forging die halves;

FIG. 15 shows another bottom perspective view of the two upper forging die halves in FIG. 14;

FIG. 16 shows a detailed view of portion D in FIG. 15 and its surrounding regions;

FIG. 17 shows a top perspective view of two lower forging die halves of the hammer head forging tool, according to various embodiments of the present patent application, with an exemplary tool parting line being shown in one of the two lower forging die halves;

FIG. 18 shows another top perspective view of the two lower forging die halves in FIG. 17;

FIG. 19 shows a detailed view of portion E in FIG. 18 and its surrounding regions;

FIG. 20 shows a method for forming a (forged) hammer head, according to various embodiments of the present patent application;

FIG. 21 shows an exemplary front perspective view of a forged hammer head, during the method for forming the forged hammer head (e.g., after forging procedure(s) and before trimming procedure), according to various embodiments of the present patent application;

FIG. 22 shows an exemplary rear perspective view of the forged hammer head of FIG. 21;

FIG. 23 shows an exemplary bottom view of the forged hammer head of FIG. 21;

FIG. 24 shows an exemplary top view of the forged hammer head of FIG. 21;

FIG. 25 shows an exemplary front view of the forged hammer head, during the method for forming the forged hammer head (e.g., after the trimming and shot blasting procedures), according to various embodiments of the present patent application;

FIG. 26 shows an exemplary rear view of the forged hammer head of FIG. 25;

FIG. 27 shows an exemplary bottom view of the forged hammer head of FIG. 25;

FIG. 28 shows an exemplary top view of the forged hammer head of FIG. 25;

FIG. 29 shows a front view of a forged hammer head, according to various embodiments of the present patent application, with a forged side nail puller;

FIG. 30 shows a partial rear view of the forged hammer head of FIG. 29 along with the forged side nail puller;

FIG. 31 shows a bottom perspective view of the forged hammer head of FIG. 1;

FIG. 32 shows another bottom perspective view of the forged hammer head of FIG. 1, wherein measurements of the forged side nail puller are shown;

FIG. 33 shows a bottom perspective view of the forged hammer head of FIG. 5;

FIGS. 34-35 show another bottom perspective views of the forged hammer head of FIG. 5, wherein measurements of the forged side nail puller are shown;

FIGS. 36-37A show another bottom perspective views of the forged hammer head of FIG. 5, wherein measurements of the forged side nail puller are shown; and

FIGS. 37B-37C show a perspective view and a cross-sectional view of the forged hammer head of FIG. 5 along with a handle and a connector configured to connect the forged hammer head and the handle.

### DETAILED DESCRIPTION

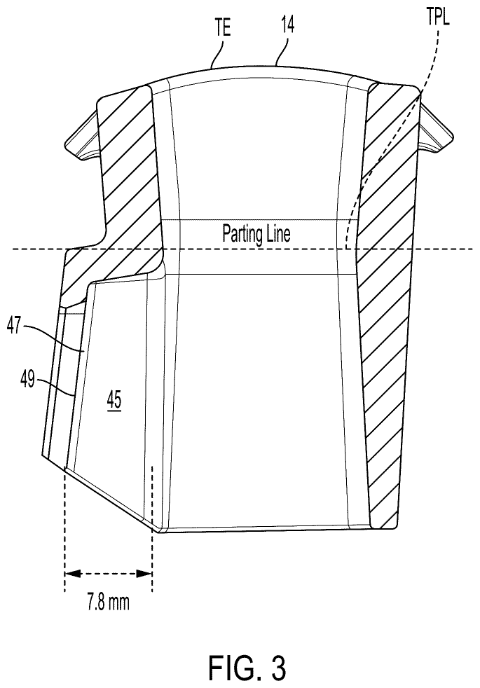

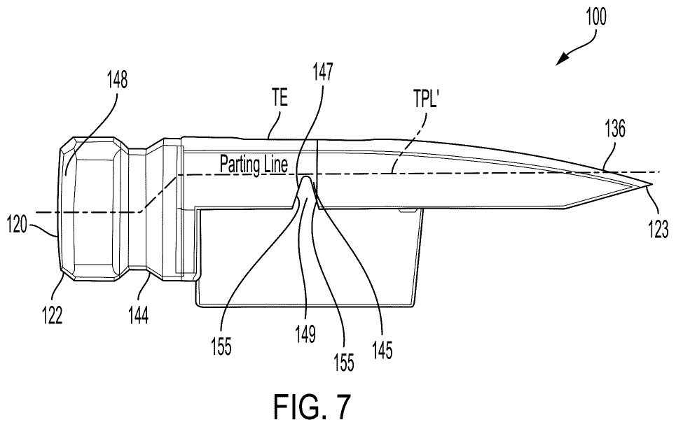

The present patent application provides a hammer 10 that includes a forged hammer head 14 formed in a forging process. The forged hammer head 14 comprises a forged hammer face 20 at one end 22 of the head 14, a forged hammer claw 36 at an end 23 of the head 14 opposite the face 20, and a forged side nail puller 45 disposed between the forged hammer face 20 and the forged hammer claw 36. The side nail puller 45 is configured to engage and pull a nail (not shown) from a workpiece (not shown). The side nail puller 45 comprises a side wall 47 and a notch 49 formed in the side wall 47. A tool parting line TPL of the forging process is above the notch 49. The tool parting line TPL of the forging process does not intersect the notch. Referring to FIG. 3, the tool parting line TPL of the forging process is above the notch 49. As will be explained in detail below, referring to FIG. 7, the tool parting line TPL′ of the forging process is above the notch 149 and the notch 191. It may be appreciated that in other embodiments, a tool parting line may be formed above the notches of the nail pullers or staple pullers of the associated hammers formed in the forging process.

As will be clear from the discussions below, the notch of the present patent application may be perpendicular to the tool parting line. The forged side nail puller may be one of the plurality of forged side nail pullers. The forged side nail puller may be on one side of the hammer head. The hammer head may further comprise a second forged side nail puller that is disposed on an opposing side of the hammer head.

The face 20 may interchangeably be referred to as hammer face, forged hammer face, striking surface, striking face or strike face. The hammer head 14 may interchangeably be referred to as head, forged head, or forged hammer head. The hammer handle 12 may interchangeably be referred to as handle, forged handle or forged hammer handle. The forging process may interchangeably referred to as forging procedure or forging operation.

The head 14 of the hammer 10 includes the strike face 20 at the one end 22 thereof, and a pair of tapered, spaced-apart nail removing claws 36 at the opposing end 23 of the head 14. The strike face 20 may be configured to strike against an object, such as a nail or a chisel. For example, the strike face 20 may be configured to strike against the head of the nail to drive the nail into the workpiece. A bell portion 44 may be located at the forward portion of the head 14 that includes the strike surface 20. The bell portion may interchangeably be referred to as bell. A chamfer or bevel 48 may be located circumferentially along the edges of the strike face 20 of the hammer 10. The strike face 20 of the hammer 10 may be slightly convex in order to facilitate square contact during driving of nails into the workpiece.

The nail removing claws 36 may interchangeably be referred to as claw or nail removing claw. The nail removing claws 36 are spaced apart to provide a V-shaped space 38 therebetween. The V-spaced space 38 of the claw 36 may interchangeably be referred to as a nail slot. The nail slot 38 is configured for removing nails from the workpiece. The nail slot 38 may be used to remove nails in two ways. One way is to engage the nail with the hammer claw 36 and use the top surface or top end TE of the hammer head 14 as a fulcrum to remove the nail from the workpiece. During this method, the hammer handle 12 is pulled in a plane that the hammer 10 is generally swung (i.e., a swing plane (may interchangeably referred to as strike plane) of the hammer 10) while the hammer head 14 is in contact with a fixed surface (e.g., work surface or workpiece from which the nail is being removed). The shank of a nail can be received in the nail slot 38 with the top surface or top end TE of the hammer 10 facing the workpiece and the nail is removed by engaging the spaced apart claws 36 with the head of the nail and withdrawing the nail from the workpiece. The second way is to engage the nail with the hammer claw 36 and pull the hammer handle 12 in a direction normal to the swing plane (i.e., pull or pivot the hammer handle laterally). This side pulling method may often generate mechanical advantage and may be useful for removing large or deeply embedded nails.

The swing plane of the hammer 10 may be a plane, which is perpendicular to the page and extends longitudinally through a center of the hammer 10. The swing plane of the hammer 10 may generally be perpendicular to a plane that passes through a central longitudinal axis L-L of the hammer 10. The swing plane of the hammer 10 may also generally be perpendicular to transverse plane(s) of the hammer 10. When the hammer 10 is swung in its swing plane, the strike face 20 strikes the object, such as the nail or the chisel. In some embodiments, no claw is provided (e.g., a ball peen hammer).

A groove 64 may be located along the top surface or top end TE of the bell 44. The groove 64 may be constructed and arranged to receive and retain a nail (not shown) therein, when the nail is placed in an initial nail driving position to facilitate the start of a nail driving operation (i.e., an operation to drive the nail into the workpiece). An opening 66 may be disposed on the bell 44 and may be configured to receive a magnet 67 therein. The magnet 67 is constructed and arranged to help retain the nail in the initial nail driving position in the groove 64 to facilitate the start of the nail driving operation. A notch 70 may be disposed on the top surface TE of the bell 44 and a surface 69 of the hammer 10 is constructed and arranged to support a head of the nail. Thus, the groove 64, the magnet 67, and the surface 69 act together to position and to initially drive the nail in a first blow into the workpiece. The nail starter arrangement that includes the groove 64, the magnet 67, and the surface 69 are optional.

The head 14 of the hammer 10 may be made of a metal material. The head 14 of the hammer 10 may be made of steel material. The head 14 of the hammer 10 may be made of iron, titanium, or other suitable metal materials or metal alloys materials.

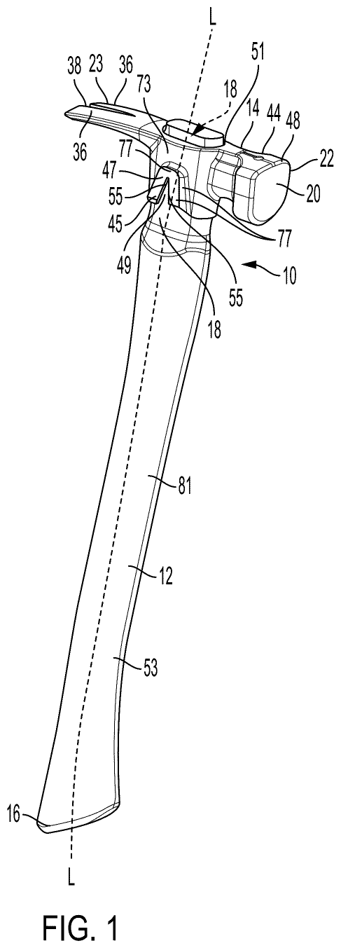

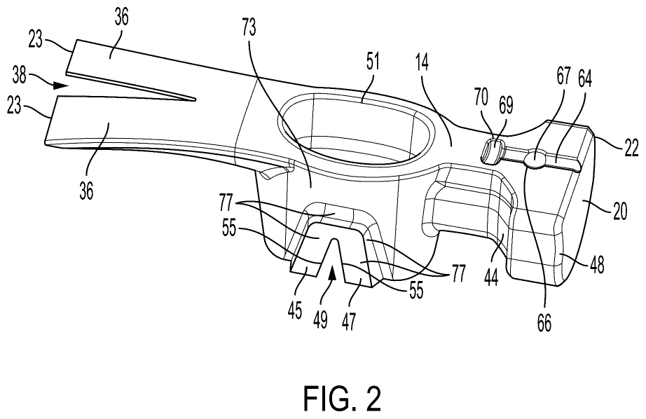

When the hammer head 14 is formed as part of a two-piece hammer, the hammer head 14 may comprise an eye-hole 51 extending therethrough for receiving the hammer handle 12. As can be clearly seen in FIGS. 1, 2, and 4, the hammer head 14 may be devoid of any structure between the notch 49 and the eye-hole 51.

The handle 12 of the hammer 10 may be made of a lighter material, such as wood, aluminum, a plastic material, a fiberglass material, or other suitable material. The handle 12 may be made of a metal material, a composite material, or a synthetic material.

The handle 12 may include an upper portion 18 and a lower portion 16. The head 14 of the hammer 10 is disposed at the upper portion 18 of the handle 12.

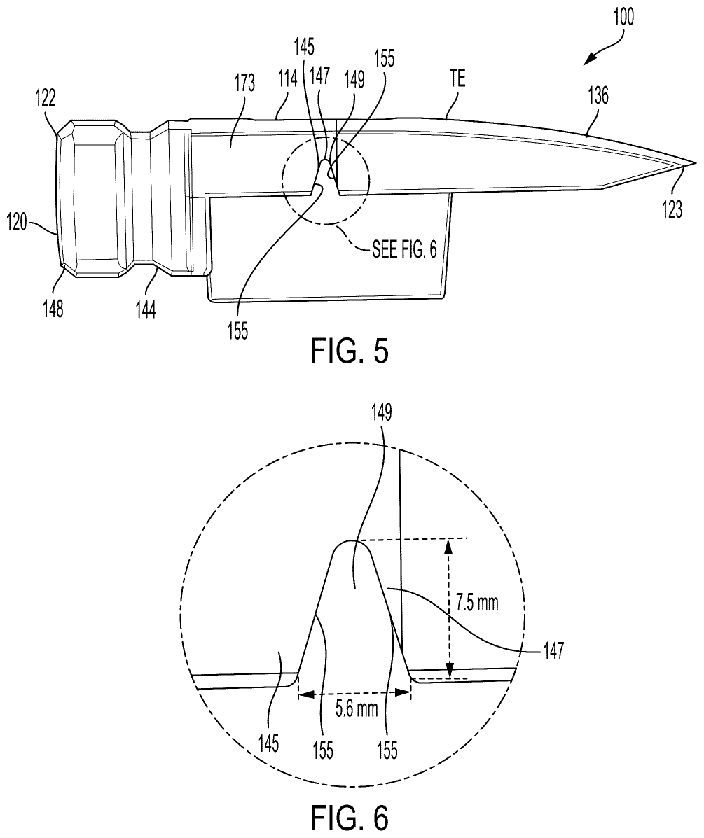

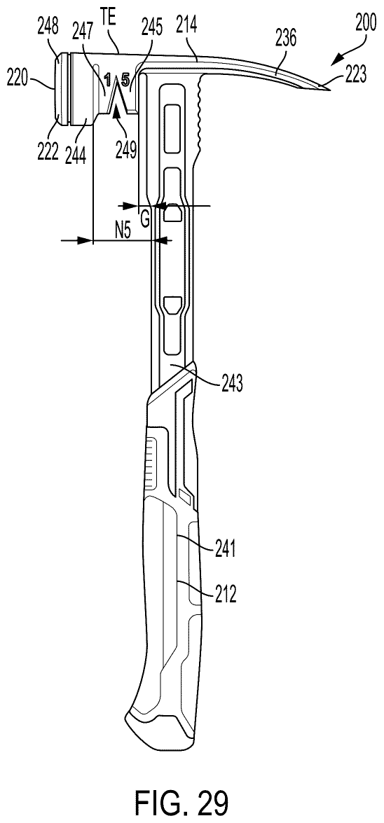

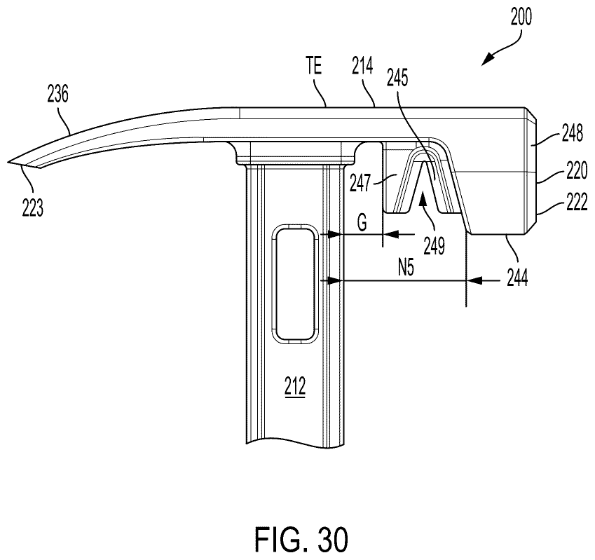

The handle 12 may also include a lower handle portion 53. The lower handle portion 53 may extend from the lower portion 16 and may extend one fourth, one third, half, two-thirds or more of the length of the handle 12. The lower handle portion 53 may be configured to receive a manually engageable grip portion thereon. The grip portion may simply be the outer surface of the handle material (e.g., wood or metal). The grip portion may be molded onto an inner or core portion/member of the handle 12. The core member of the handle 12 may have protrusions, through holes, and or other similar structures to provide a mechanical interface for an overmolded material (i.e., material of the grip portion). That is, these structures are configured to enable a mechanical bond to be formed between the core member of the handle 12 and the material of the grip portion that is overmolded thereon. These structures are configured to provide interlocks for the material of the grip portion to take hold of the core member of the handle 12 and/or to allow the material of the grip portion to flow/pass therethrough. The material of the grip portion may be configured to conform to the cross-sectional shaped configuration of the core member of the handle 12. The grip portion is made of an elastomeric material, a rubber based material, a plastic based material or other suitable material. Optionally, the grip portion can be ergonomically shaped. As will be clear from the discussions below with respect to FIGS. 29-30, a grip portion 241 may be molded onto an inner or core portion/member 243 of the handle 212. The handle configuration with a grip portion molded onto an inner or core portion/member may be used with the hammers in FIGS. 1-4 and in FIGS. 5-13 as would be appreciated by a person of ordinary skill in the art.

FIGS. 1-4 show a two-piece hammer 10 having the forged hammer head 14 and the forged side nail puller 45 in accordance with an embodiment and FIGS. 5-13 show a two-piece hammer 100 having the forged hammer head 114 and the forged side nail pullers 145 and 185 in accordance with another embodiment, while FIGS. 29-30 show a one-piece hammer 200 having the forged hammer head 214 and the forged side nail puller 245 in accordance with yet another embodiment. The embodiment of FIGS. 1-4 is provided with reference numerals in a two-digit format, each embodiment thereafter is provided with reference numerals in successive “100s” series (e.g., 100, 200, etc.). For example, the embodiment of FIGS. 5-13 is provided with reference numerals in 100 series, and the embodiment of FIGS. 29-30 is provided with reference numerals in 200 series. Features in later embodiments similar to those in earlier embodiments are given the same basic reference number in successive series as in the original series (e.g., head 14 and heads 114, 214, etc.). The use of the same or similar reference numerals in different figures indicates similar, related, or identical items. The embodiments have many identical parts in structure, and therefore the description may have been omitted. Where the construction and/or operation of such embodiment features/parts is not described, the reader may assume that construction and operation are the same as described in other portions of the present patent application, having regard to those modifications apparent to a person of ordinary skill in the art. The hammer as shown and described with respect to FIGS. 5-13 is very similar to the hammer as shown and described with respect to FIGS. 1-4, except for the differences noted in the present patent application.

The present patent application also provides the forged hammer head 14 for a two-piece hammer. The hammer head 14, 114 may be formed as part of a two-piece hammer 10, 100. The hammer head 14, 114 is formed in the forging process. The hammer head 14, 114 includes the forged hammer face 20, 120 at one end 22, 122 of the head 14, 114, the forged hammer claw 36, 136 at the end 23, 123 of the head 14, 114 opposite the face 20, 120, and the forged side nail puller 45, 145, 185 disposed between the forged hammer face 20, 120 and the forged hammer claw 36, 136. The side nail puller 45, 145, 185 is configured to engage and pull a nail from a workpiece. The side nail puller 45, 145, 185 comprises the side wall 47, 147, 189 and the notch 49, 149, 191 formed in the side wall 47, 147, 189. The hammer head 14, 114 has the eye-hole 51, 151 extending therethrough for receiving the hammer handle 12. The hammer head 14, 114 is devoid of any structure between the notch 49, 149, 191 and the eye-hole 51, 151.

The hammer handle (along with its upper portion) is not shown in FIGS. 5-13 but the hammer handle in the embodiment of FIGS. 5-13 will be similar to that (i.e., the hammer handle 12 along with its upper portion 18) shown in the embodiment of FIGS. 1-4 or any other hammer two-piece hammer handle configuration as would be appreciated by a person of ordinary skill in the art. The head 14, 114 and the handle 12 may be formed separately and then connected to one another. In one embodiment, the hammer head 14, 114 is formed by forging process/procedure and the forged hammer head 14, 114 may then be connected to the handle 12.

The head 14, 114 may be mounted on the upper portion 18 of the handle 12 by securing the upper portion 18 of the handle 12 into a portion (e.g., the eye-hole 51, 151) of the head 14, 114. Any suitable manner of connecting the head 14, 114 and the handle 12 may be employed. In one embodiment, the handle 12 can be made from a different material than the head 14, 114. For example, the hammer handle 12 may be made from a wood material or a fiberglass material, and the head 14 may be forged using metal material to form the forged hammer head 14 as shown and described in the embodiment of FIGS. 1-4 and also in the embodiment of FIGS. 5-13. In another embodiment, the handle 12 can be made from the same material than the head 14, 114.

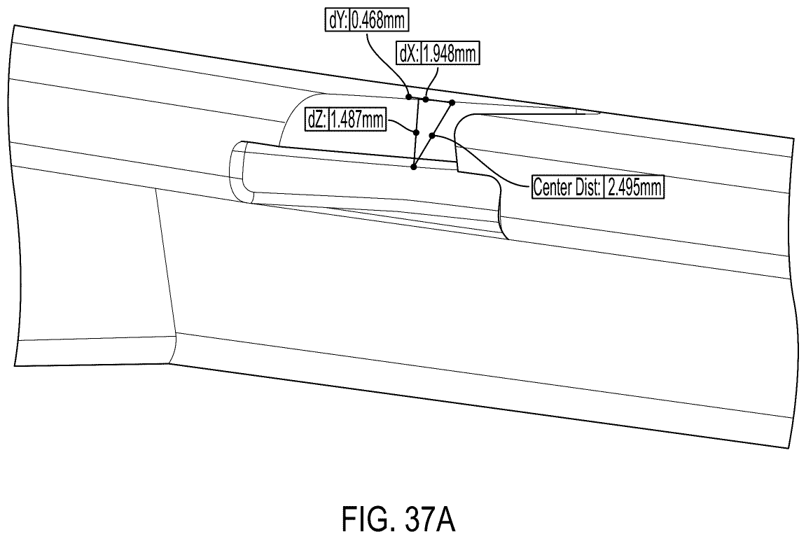

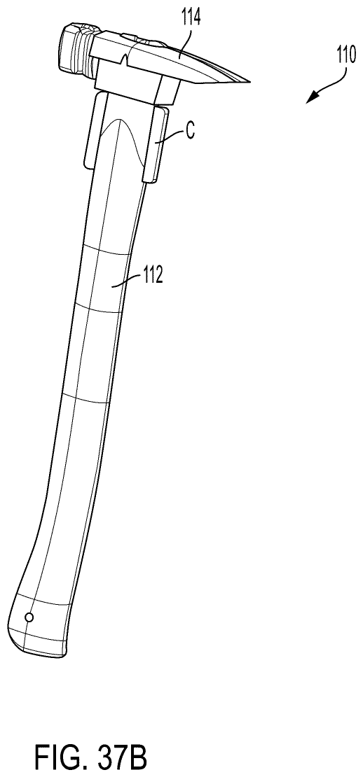

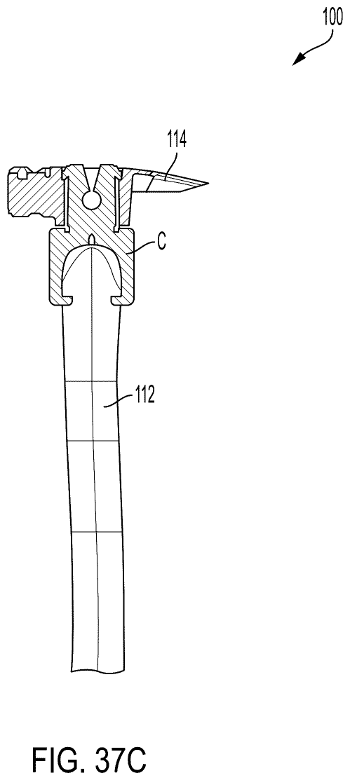

FIGS. 37B-37C show a perspective view and a cross-sectional view of the forged hammer head 114 of FIG. 5 along with a handle 112 and a connector C connecting the forged hammer head 114 and the handle 112.

The hammer head 214 may be formed as part of a one-piece hammer. The hammer head 214 may be integrally formed as part of the same forging process as the hammer handle 212. The head 214 may be integrally formed with the handle 212. In this embodiment, the handle 212 has a metal (e.g., steel, iron, titanium, or other metal materials or alloys) shaft 212 integrally formed with the head 214 of the same material. In one embodiment, a covering/grip portion of different material (e.g., an elastomer material) may be provided on top of the metal shaft 212 as discussed in detail above.

Although the hammer head 14 (of FIGS. 1-4), 114 (of FIGS. 5-13) is shown as having the eye-hole 51, 151 extending therethrough for receiving the hammer handles to be formed as two-piece hammers. In another embodiment, the hammer head 14 (of FIGS. 1-4), 114 (of FIGS. 5-13) may be formed as part of a one-piece hammer in which the hammer head may be integrally formed as part of the same forging process as the hammer handle.

The side nail puller 45 is configured to engage and pull/remove the nail from the workpiece. The side nail puller 45 is located on the side of the hammer 10, such that the nail is engaged when the hammer 10 is laid nearly parallel to the workpiece or the work surface/surface of the workpiece from which the nail is to be removed.

In two-piece hammer configuration, the side nail puller 45 may be formed by the same forging process as the hammer head 14. In one-piece hammer configuration, the side nail puller 45 may be formed by the same forging process as both the hammer head 14 and the hammer handle 12. The forged side nail puller 45 is disposed between the forged hammer face 20 and the forged hammer claw 36.

The side nail puller 45 includes the notch 49 suitable for engaging various sizes of nail heads or shanks. The notch 49 may be V-shaped configuration. The notch 49 may be substantially in line with the handle 12 of the hammer 10. In another embodiment, as shown in FIGS. 29-30, the notch 249 of the side nail puller 245 may be offset with respect to the handle 212 of the hammer 200 as will be described in detail in discussions below. The forged hammer head 14 of the hammer 10 of FIGS. 1-4 may have a weight of approximately 16-20 ounces (oz), but in other embodiments (e.g., where the hammer is scaled), the weight of the forged hammer head may be approximately between 10-24 oz depending on material selection (e.g., titanium vs steel) and intended size/heft. As understood throughout this disclosure, in some embodiments the term “approximately” may be understood as a tolerance range of +/−15%.

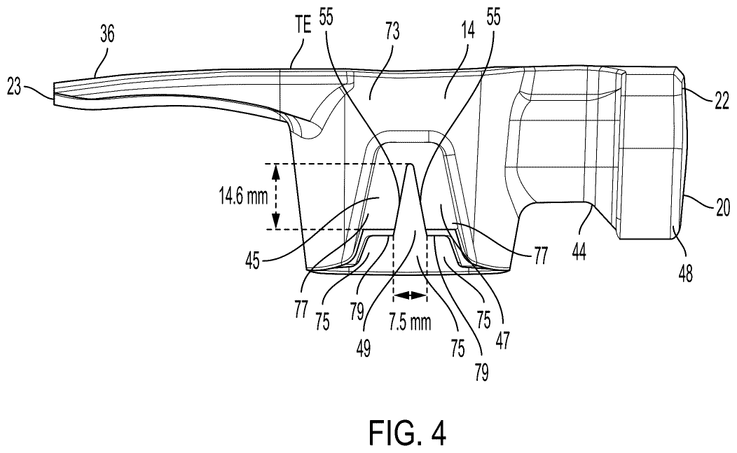

Referring to FIG. 3, the tool parting line TPL of the forging process is above the notch 49. That is, the notch 49 is below the tool parting line TPL of the forging process. Referring to FIG. 4, the base width of the notch 49 is approximately 7.5 millimeters (mm) and the total height of the notch 49 is approximately 14.6 mm. Also, referring to FIG. 3, the depth (e.g., the amount the side nail puller 45 protrudes away from an outer surface 73 of the forged hammer head 14) of the side nail puller 45 is approximately 7.8 mm. The side nail puller 45 along with its notch 49 is configured to remove common nail sizes that are in the range between 2d to 20d nails.

The side nail puller 45 may interchangeably be referred to as a 180 degree side nail puller. The position of the side nail puller 45 is configured to give the user nearly 180 degrees of rotation to remove the nail from the workpiece. When using the side nail puller 45, the hammer 10 is laid almost parallel to the workpiece/the work surface to engage the nail. The nail may be removed completely with one movement. The leverage of the handle 12 is magnified because the fulcrum point when using the side nail puller 45 is usually close to the nail that is removed from the workpiece/the work surface.

The side wall 47 of the nail puller 45 includes edges 55 on opposite sides of the notch 49. The notch 49 is constructed and arranged to allow the head of a nail fit in the notch 49, and the tapered configuration of the edges 55 allows the hammer 10 to be slid over the nail until the shank of the nail is grasped by the edges 55. Once the nail is engaged, the hammer 10 may be rotated about an axis approximately perpendicular to the strike face 20 to remove the nail from the workpiece. The edges 55 may be interchangeably referred to as nail engagement edges. The edges 55 may include corners at their bottom ends. The bottom ends of the side wall 47 of the side nail puller 45 lie in a horizontal plane, the bottom ends of the hammer head 14 lie in a horizontal plane, and these horizontal planes may be parallel to each other. The edges 55 may lie in a plane that may be parallel to the strike plane. The edges 55 may lie in a plane that may not be parallel to the strike plane. The edges 55 may be curved upward in a convex manner, when viewed from the work surface. The convex shape of the edges 55 may allow the side nail puller 45 to dig into a substrate, such as wood, and engage a nail head. The shape may be a similar design as for a ‘cat's paw’ or similar nail extracting tools. The edges 55 may be formed by a surface that is substantially flat. The edges 55 may be formed by a surface that is substantially curved in a convex manner. The particular angle of the edges 55 that form the notch 49 and the curvature (if any) of the surface (that is substantially curved in a convex manner) may be varied to give more or less ease of engagement of the nail and structural integrity of the side nail puller 45.

Referring to FIG. 4, the side wall 47 of the side nail puller 45 includes front/top surfaces 77 and opposing rear/bottom surfaces 79. The rear surfaces 79 of the side nail puller 45 face outer surfaces 81 (shown in FIG. 1) of the hammer handle 12. The hammer head 14 is devoid of any structure between the notch 49 and the eye-hole 51. Similarly, as explained with respect to FIG. 5-13, the hammer head 114 is devoid of any structure between the notch 149, 191 and the eye-hole 151. The side nail puller 45 is configured to project forwardly from the outer surface 73 of the hammer head 14. The side nail puller 45 may include a pocket 75 that lies therewithin. The pocket 75 is formed by the side wall 47 of the side nail puller 45. On one side, the pocket 75 is surrounded by the side wall 47 of the side nail puller 45, including the notch 49. On the other side, the pocket 75 is surrounded by the outer surfaces 81 (shown in FIG. 1) of the hammer handle 12.

The pocket 75 is sized to receive therewithin and capture a head of a nail that protrudes from a workpiece. The nail enters the side nail puller 45 via the notch 49 that communicates with the pocket 75. An outward pulling force may be applied to the hammer handle 12 of the hammer 10. This force is transferred from the side nail puller 45 to the head of the nail captured within the pocket 75 so that the nail can be removed from the workpiece/work surface.

The pocket 75 may be configured allow the side nail puller 45 to engage a nail at any point along its shank. For example, if a nail has a crooked head or bent shank, the head of the nail may be fit through the wide end of the notch 49 and the side nail puller 45 may be slid until the nail engagement edges 55 firmly grip the nail shank near the workpiece from which the nail is to be removed. The bent head and crooked portion of the nail may protrude into the pocket 75 without compromising the effectiveness of the nail puller.

The side nail puller 45 is used to remove nails in addition to other features on the hammer 10. For example, in some circumstances, the claw 36 may not have enough clearance nearby the nail on which to rest the fulcrum portion of the head 14. Similarly, the distance between the pulling point of the claw 36 and the pivot or fulcrum point of the head 14 may be longer than the distance between the pulling point and fulcrum point of the side nail puller 45. In such a case, the pulling force required on the hammer handle 12 to remove the nail is substantially less for the side nail puller 45 than with the claw 36. Various head geometries and shapes may be used to increase and decrease the leverage exerted on the hammer handle 12 when using the side nail puller 45. For example, by rounding over the top surfaces of the hammer head 14, the nail pulling action of the side nail puller 45 is smoother than when the hammer head 14 has more of a squared top

The tool parting line TPL may have a relatively straight line configuration in FIG. 3. The tool parting line TPL′ may have a stepped configuration as shown in FIGS. 7 and 10.

Striking tools other than a hammer may be used with the side nail puller 45, 145, 245. For example, a hatchet, ball peen hammer, sledge, or other striking tools may have side nail puller 45, 145, 245 fashioned in a similar manner.

The forged hammer head 114 of the hammer 100 of FIGS. 5-13 may include the forged front side nail puller 145 on the front of the hammer 100 and may also include the forged rear side nail puller 185 and a forged rear side staple puller 187 on the rear/back of the hammer 100. Although not specifically identified in the figures, the forged front side nail puller 145, the forged rear side nail puller 185 and the forged rear side staple puller 187 each may have the pocket (similar to the pocket 75), the front surfaces (e.g., similar to the front surfaces 77), and the rear surfaces (e.g., similar to the rear surfaces 79), etc. Also, the forged rear side nail puller 185 and the forged rear side staple puller 187 both may have edges (similar to the edges 55, 155). The edges 155 may include rounded corners at their bottom ends (as shown in FIGS. 5-13).

The tool parting line TPL′ is shown in FIGS. 7 and 10. The tool parting line TPL′ may have a stepped configuration as shown in FIGS. 7 and 10. The stepped tool parting line TPL′ may be configured to create a shelf for the nail puller 145. Such a stepped tool parting line may permit generation of a side nail puller without post-forging processing. This could also reduce tooling required for manufacturing processes. The stepped parting line may also reduce wear on tooling. Such advantages may reduce tooling manufacturing and replacement costs. It may also be appreciated that such stepped parting lines may create more visually appealing or ergonomically beneficial shapes of head forgings (e.g., by offsetting the side nail puller from the center of the hammer strike face).

The notch 149 of the forged front side nail puller 145 of the hammer 100 of FIGS. 5-13 is disposed below the tool parting line TPL′ as shown in FIG. 7. That is, the tool parting line TPL′ of the forging process is above the notch 149.

The rear side nail puller 185 of the hammer 100 of FIGS. 5-13 may include a side wall 189 and a notch 191 formed in the side wall 189. The notch 191 of the forged rear side nail puller 185 of the hammer 100 of FIGS. 5-13 may have a V-shaped configuration. The forged rear side staple puller 187 of the hammer 100 of FIGS. 5-13 may include a side wall 193 and a notch 195 formed in the side wall 193. The notch 195 of the rear side staple puller 187 of the hammer 100 of FIGS. 5-13 may have a U-shaped configuration. The rear side staple puller 18 of the hammer 100 of FIGS. 5-13 includes surfaces that are configured for slipping under and prying loose staples.

The notch 191 of the forged rear side nail puller 185 of the hammer 100 of FIGS. 5-13 is disposed above the tool parting line TPL′ as shown in FIG. 10. The notch 195 of the forged rear side staple puller 187 of the hammer 100 of FIGS. 5-13 is also disposed above the tool parting line TPL′ as shown in FIG. 10.

The forged hammer head 114 of the hammer 100 of FIGS. 5-13 may have a weight of approximately 20 ounces (oz).

Referring to FIG. 7, the tool parting line TPL′ of the forging process is above the notch 149. That is, the notch 149 is below the tool parting line TPL′ of the forging process. Referring to FIGS. 5-6, the base width of the notch 149 of the front side nail puller 145 is approximately 5.6 mm and the total height of the notch 149 of the front side nail puller 145 is approximately 7.5 mm. Also, the depth (e.g., the amount the front side nail puller 145 protrudes away from the front outer surface of the forged hammer head 114) of the front side nail puller 145 is approximately between 1 mm and 25 mm depending on the scale of the hammer, and in the illustrated embodiment is approximately 4 mm.

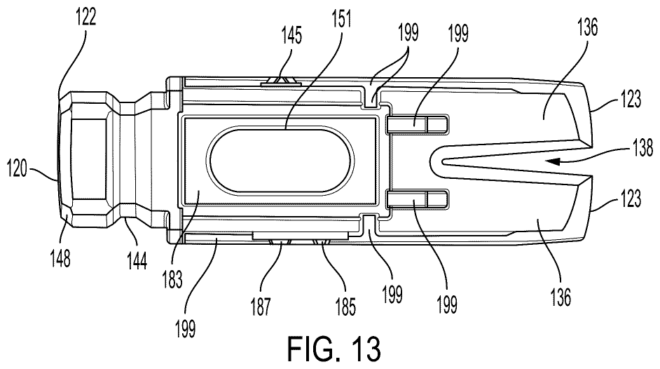

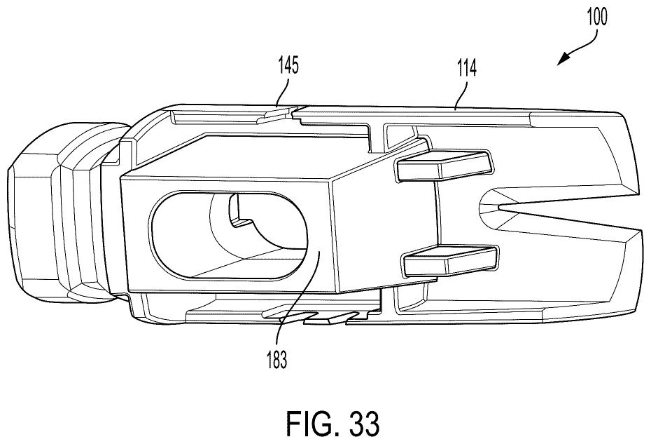

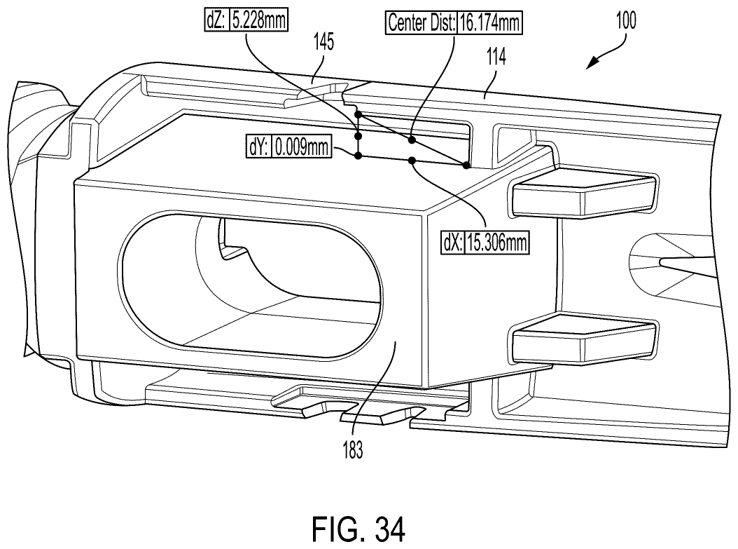

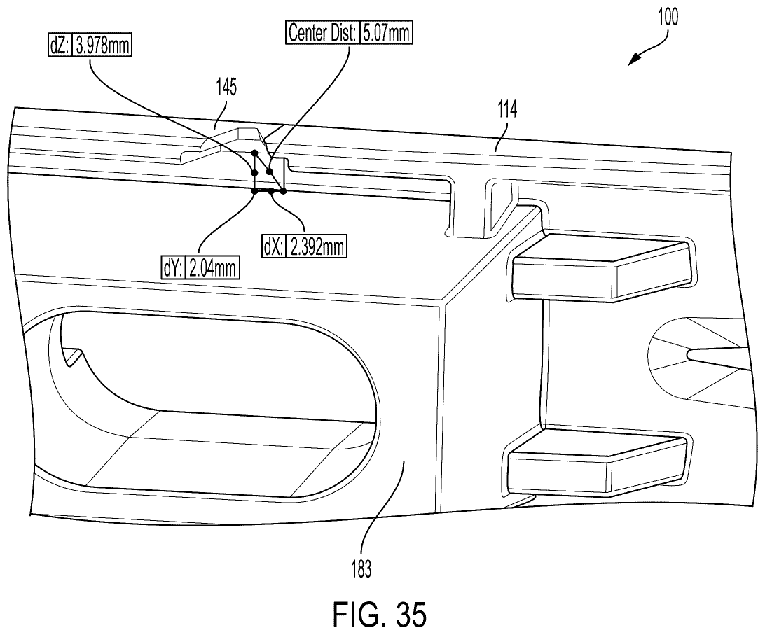

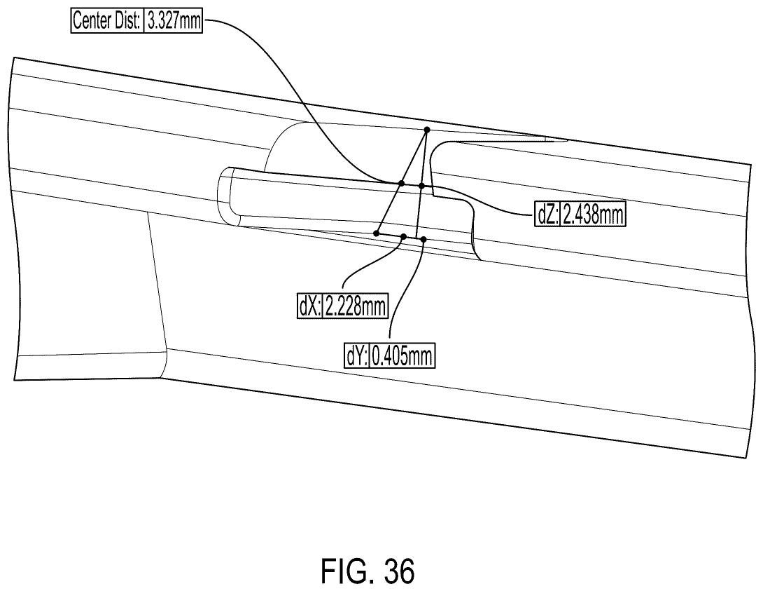

FIG. 33 shows a bottom perspective view of the forged hammer head 114 of FIG. 5. FIGS. 34-37A the measurements of the forged side nail puller 145 for the forged hammer 114 head of FIG. 5. As shown in FIGS. 34-35, the nail puller 145 extends from the shell 183 (as shown in FIG. 13) approximately between 4 and 5.25 mm but as noted that extension of the nail puller 145 from the central shell 183 could be significantly wider in scaled up embodiments. The shell 183 is angled, so that measurement does grow as you move closer to the handle, with the thickness of a stepped formation of the nail puller 145 ranging from approximately 1.5 mm (as shown on FIG. 37A) for the smaller step to approximately between 2.5 and 2.7 mm for the full thickness (as shown in FIG. 36). The measurements for the nail puller 145 may also be similar for pullers 185 and 187 on the opposing side of the forged hammer 114.

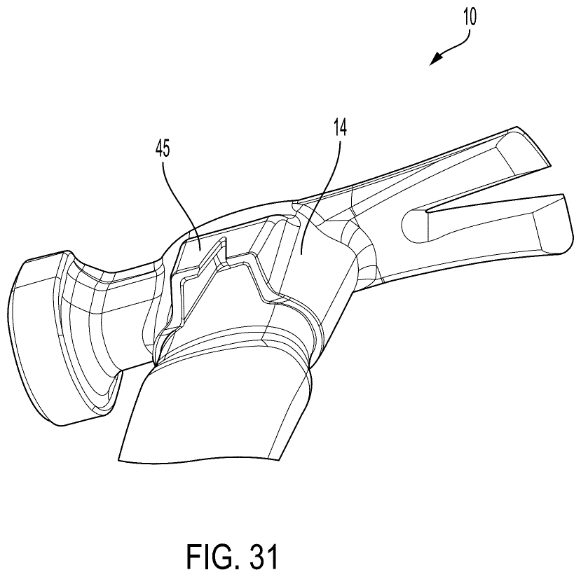

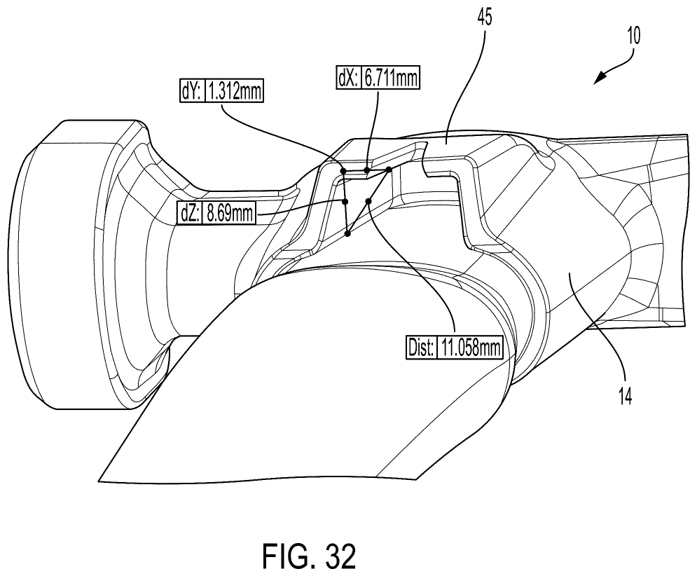

FIG. 31 shows a bottom perspective view of the forged hammer head 14 of FIG. 1. FIG. 32 shows the measurements of the forged side nail puller 45 for the forged hammer head 14 of FIG. 1. As shown in FIG. 32, the measurements of the forged side nail puller 45 for the forged hammer head 14 show how the gap can vary.

The side nail puller 145 (also interchangeably referred to as the front side nail puller) along with its notch 149 is configured to remove common nail sizes that are in the range between 3d to 16d nails. The 3d nails may generally have a gauge of 14, nominal shank diameter of 0.083 inches, nominal shank length of 1.25 inches, and head diameter of approximately 13/64 inches. The 16d nails may generally have a gauge of 8, nominal shank diameter of 0.165 inches, nominal shank length of 3.5 inches, and head diameter of approximately 11/32 inches.

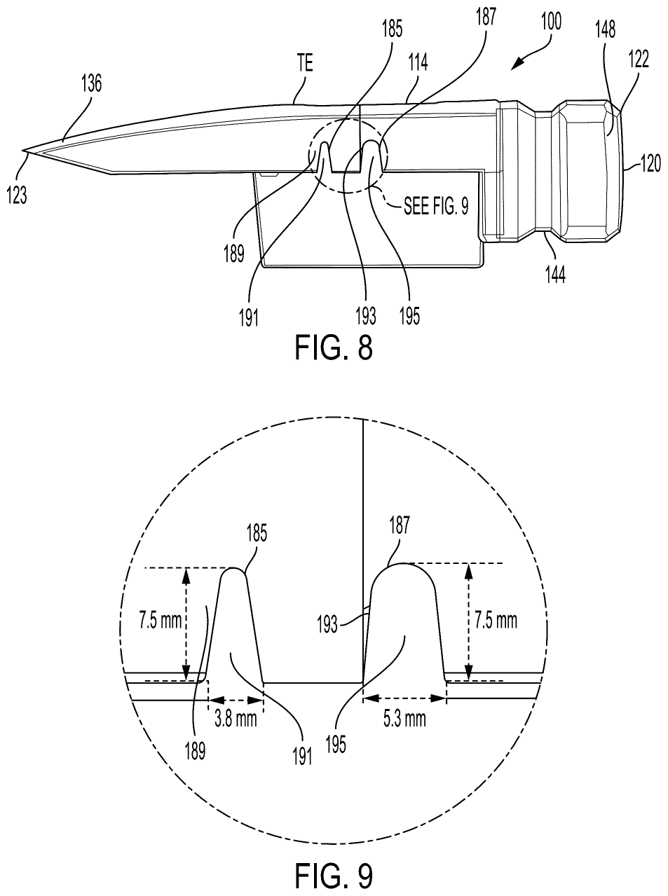

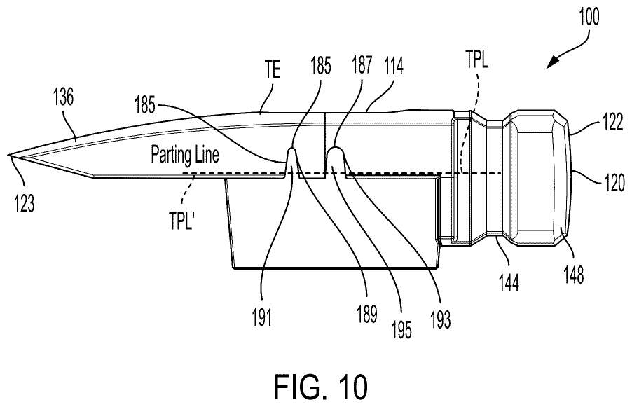

Referring to FIGS. 8-9, the base width of the notch 191 of the rear side nail puller 185 is approximately 3.8 mm and the total height of the notch 191 of the rear side nail puller 185 is approximately 7.5 mm. The depth (e.g., the amount the rear side nail puller 185 protrudes away from a shell 183 (as seen in greater detail in the bottom view of FIG. 13 of the forged hammer head 114) of the rear side nail puller 185 is approximately 1-25 mm.

Also, referring to FIGS. 8-9, the base width of the notch 195 of the forged rear side staple puller 187 is approximately 5.3 mm and the total height of the notch 195 of the forged rear side staple puller 187 is approximately 7.5 mm. The depth (e.g., the amount the rear side staple puller 187 protrudes away from the shell 183) of the side staple puller 187 is approximately 1-25 mm in some embodiments, and in some embodiments may be the same as the depth of the rear side nail puller 185, which may provide a generally symmetrical appearance but for the nail or staple pulling configuration on opposing sides of the forged hammer head 114.

The heights of the front side nail puller 145, the rear side nail puller 185 and the rear side staple puller 187 may all be the same. Referring to FIGS. 6 and 9, the heights of the front side nail puller 145, the rear side nail puller 185 and the rear side staple puller 187 are all approximately 7.5 mm. The heights of the front side nail puller 145, the rear side nail puller 185 and the rear side staple puller 187 may be different from each other.

The depths (e.g., the amount of protrusion away from the outer surface of the hammer head 114) of the front side nail puller 145, the rear side nail puller 185 and the rear side staple puller 187 may all be the same. The depths (e.g., the amount of protrusion away from the outer surface of the hammer head 114) of the front side nail puller 145, the rear side nail puller 185 and the rear side staple puller 187 may be different from each other.

The base width of the notch 191 of the rear side nail puller 185 may be different from the base width of the notch 149 of the front side nail puller 145. Referring to FIGS. 6 and 9, the base width of the notch 191 of the rear side nail puller 185 is approximately 3.8 mm, which is smaller than the base width of the notch 149 of the front side nail puller 145 of approximately 5.6 mm. The base width of the notch 191 of the rear side nail puller 185 may be the same as the base width of the notch 149 of the front side nail puller 145.

The base widths of the notch 191 of the rear side nail puller 185, the notch 149 of the front side nail puller 145, and the notch 195 of the rear side staple puller 187 may all be the same. The base widths of the notch 191 of the rear side nail puller 185, the notch 149 of the front side nail puller 145, and the notch 195 of the rear side staple puller 187 may all be different. As shown in FIGS. 6 and 9, the base width of the notch 191 of the rear side nail puller 185 is approximately 3.8 mm, which is smaller than the base width of the notch 195 of the rear side staple puller 187 of approximately 5.3 mm, which in turn is smaller than the base width of the notch 149 of the front side nail puller 145 of approximately 5.6 mm.

The rear side nail puller 185 along with its notch 191 is configured to remove common nail sizes that are in the range between 2d to 20d nails. The 2d nails may generally have a gauge of 15, nominal shank diameter of 0.072 inches, nominal shank length of 1 inch, and head diameter of approximately 3/16 inches. The 2d nails may generally have a gauge of 14, nominal shank diameter of 0.083 inches, nominal shank length of 1 inch, and head diameter of approximately 13/64 inches. The 20d nails may generally have a gauge of 6, nominal shank diameter of 0.203 inches, nominal shank length of 4 inches, and head diameter of approximately 13/32 inches.

The rear side staple puller 187 along with its notch 195 is configured to remove common heavy duty or light duty staple sizes, such as ¼″, 5/16″, ⅜″, ½″ or other staples sizes that are known in the art, with known gauges of wire The staple puller may be optional.

In illustrated embodiment, the front side of the forged hammer head 114 includes a single nail puller and the rear side of the forged hammer head 114 includes a staple puller and a different sized nail puller (i.e., compared to the front side nail puller). The front side of the forged hammer head 114 may include a nail puller and a staple puller. The front side of the forged hammer head 114 may include two different sized staple pullers. The front side of the forged hammer head 114 may include two different sized nail pullers. The rear side of the forged hammer head 114 may include a single nail puller. The rear side of the forged hammer head 114 may include two different sized nail pullers. The rear side of the forged hammer head 114 may include two different sized staple pullers.

The side nail pullers 145 and 185 of FIGS. 5-13 may be disposed at a higher location/position on the hammer head 114 than the side nail puller 45 of FIGS. 1-3 is disposed on the hammer head 10. That is, the side nail pullers 145 and 185 of FIGS. 5-13 may be disposed on the upper portions of the hammer head 114 compared to the side nail puller 45 is disposed on the hammer head 10 in FIGS. 1-3. This configuration in which the side nail pullers 145 and 185 are positioned at a higher location/position or the upper portions of the hammer head 114 increases the leverage of the hammer 100.

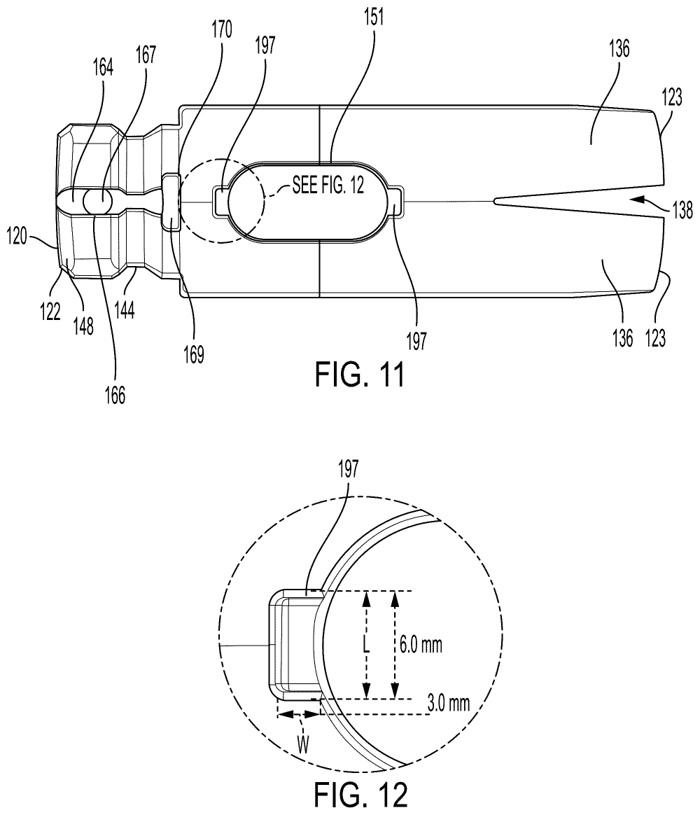

Referring to FIGS. 11-12, the hammer 100 may include the eye-hole 151 configured for receiving portions of the hammer handle. The eye-hole 151 of the forged hammer head 114 may be a cavity that is configured for steel core configuration. The handle of the hammer 100, or a shaft of a handle (e.g., as a core of a handle that is overmolded or otherwise covered with a grip) may be connected to the forged hammer head 114 using welding or other conventional attachment/connecting procedures. The forged hammer head 114 of the hammer 100 of FIGS. 5-13 may alternatively be compatible with receiving a wooden handle and/or a fiberglass handle. In other embodiments, at least part of a shaft of the handle may be forged alongside the forged hammer head 100. Indeed, it may be appreciated that in any embodiment of the hammers herein, the assembly of the hammer head to a handle, or co-forging of the hammer head and at least part of a shaft of a handle, may be through any appropriate mechanism, including being forged separately and being welded together, being fastened together, or so on.

The hammer 100 may also include guide cavities 197 for connecting/attaching the handle and/or an interlocking part/component (e.g., that interconnects/interlocks the hammer head 114 and the hammer handle). The hammer 100 may include two guide cavities 197. The length L of the guide cavity 197 may be approximately 6.0 mm and the width W of the guide cavity 197 may be approximately 3.0 mm. The number of the guide cavities may vary. For example, The hammer 100 may include four guide cavities, one on each side of the eye-hole 151. The dimensions of the guide cavities may be the same. The dimensions of the guide cavities may be different from each other. The guide cavities may be optional. For example, the hammer 10 of FIGS. 1-4 does not include guide cavity or cavities for connecting/attaching the handle 12 and/or an interlocking part/component (e.g., that interconnects/interlocks the hammer head 14 and the hammer handle 12). The hammer 100 may include head retention features that are shown and described in detail in, for example, U.S. Patent Application Ser. No. 63/250,495, titled “Head Retention For Striking Tool”, filed on Nov. 14, 2023, the entire contents of which are incorporated herein by reference.

Referring to the bottom view in FIG. 13, the forged hammer head 114 of the hammer 100 may have a shell and rib configuration. That is, the hammer head 114 may include a shell 183. The shell 183 may include one or more ribs 199. The notches 149, 191, 195 of the side nail pullers 145, 185 and the staple puller 187 may be disposed on the ribs 199, which may increase structural stability and serve to reinforce the shell 183 and the claw 136 and side nail pullers 145 and 185 extending from the shell 183.

In some embodiments, such as those shown in FIGS. 29-30, the side nail puller 245 of hammer 200 may be located in a negative space NS between the strike face 220 and the handle shaft/handle 212.

The hammer 200 may provide a forgeable design of the hammer head 214 that may include the side nail puller 245, and may in some embodiments include a shaft or handle for the hammer 200. The hammer head 214 may have a tool parting line that is perpendicular to those described above by locating the side nail puller 245 in the negative space NS between the strike face 220 and handle shaft/handle 212.

In the illustrated embodiment, the hammer 200 may include a gap G that is provided (in the negative space NS and) between the handle shaft/handle 212 and the side nail puller 245. The gap G between the handle shaft/handle 212 and the side nail puller 245 may be configured to more easily allow forgeability and visibility to see the nail that is being pulled from the workpiece. In another embodiment, there is no gap between the handle shaft/handle 212 and the side nail puller 245. That is, the nail puller 245 may extend entirely between the handle shaft/handle 212 and strike face 220 and may extend the entire negative space NS so as to form a full bridge between the handle shaft/handle 212 and the strike face 220.

It may be appreciated that various geometries of the hammer configurations disclosed herein may be separately protectable without regard to manufacturing methods otherwise described herein. For example, the positioning of the side nail puller 245 of hammer 20 in the negative space NS between the strike face 220 and the handle shaft/handle 212 in the hammer 200 may be novel even when created other than through forging together. As such, in some embodiments the side nail puller 245 may be an insert (e.g., sheet metal) that may be secured in the negative space NS by any appropriate manner, including but not limited to being welded in or being fastened to, or may be formed in the negative space by any appropriate mechanism outside of forging, including but not limited to being machined out of the space.

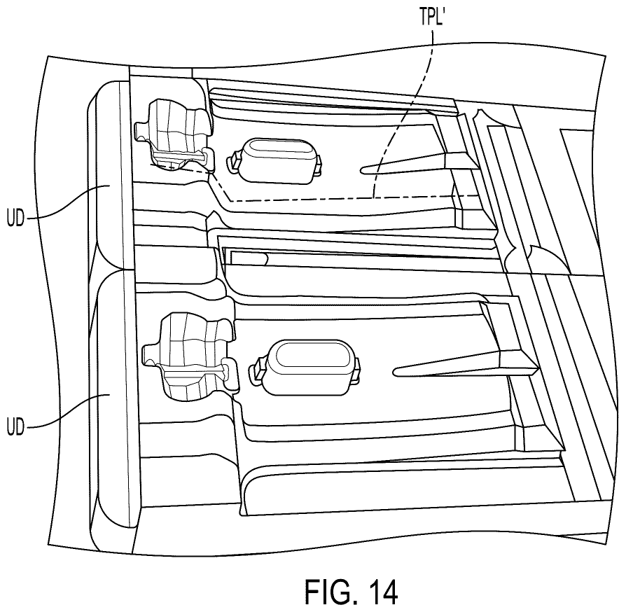

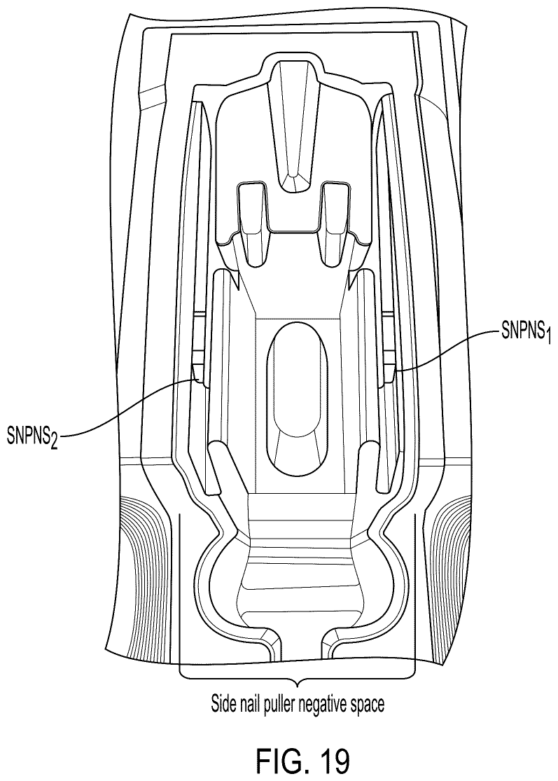

Referring to FIGS. 14-28, the present patent application also provides a method M for forming the hammer head 114. The method comprises sequentially placing a blank in a series of cooperating forging dies UD, LD, and sequentially shaping the blank in the forging dies UD, LD into the hammer head 114, the hammer claw 136, and the side nail puller 145, 185 disposed between the face 120 and the hammer claw 136. The side nail puller 145, 185 includes the side wall 147, 189 and the notch 149, 191 formed in the side wall 147, 189. The tool parting line TPL′ may be formed at an interface of the die portions UD, LD. The tool parting line TPL′ may be formed above the notch 149, 191. The hammer head may be configured to be coupled to or formed with a handle shaft. The notch may extend generally parallel to an axis of elongation for the handle shaft.

The cooperating forging dies may include an upper forging die UD and a lower forging die LD. The series of cooperating forging dies may include two or more cooperating forging dies. The same blank may be sequentially placed/positioned in the series of cooperating forging dies and the same blank may be sequentially shaped in the forging dies UD, LD into the forged hammer head 114. As will be clear from the discussions below, the blank may interchangeably be referred to as billet. The forging dies UD, LD may comprise at least two die portions. The number of die portions in the forging dies may vary. In one embodiment, the forging procedure may include a single forging procedure. The hammer heads and side nail pullers of the present patent application are forgeable with a single step procedure. The generally mid-level parting line is configured to facilitate the single step forging procedure, as well as the taper draft shape lending itself to eliminating waste material. By contrast, the side nail puller pocket shape of the '432 Patent would be virtually impossible to forge. In another embodiment, the forging operation/procedure may include one or more forging operations/procedures.

Although the method M is described for forming the hammer head 114 of FIGS. 5-13, the same method may be used for forming the hammer head 14 of FIGS. 1-4 and/or the hammer head 214 of the FIGS. 29-30 as would be appreciated by a person of ordinary skill in the art.

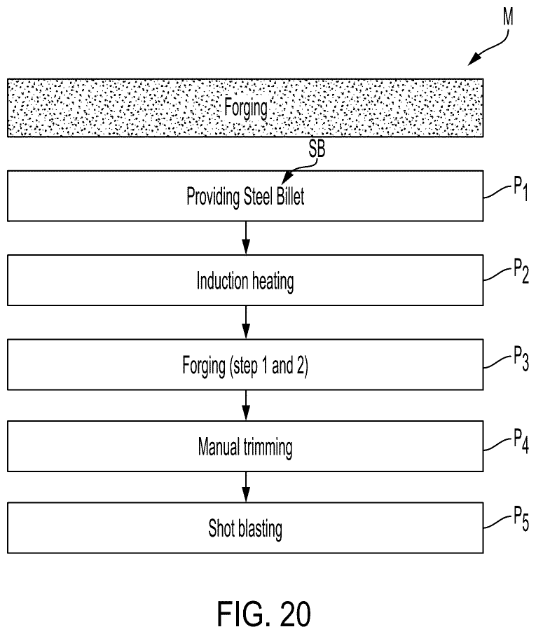

Referring to FIG. 20, the method M includes a procedure P₁ at which a steel billet SB is provided, a procedure P₂ at which the steel billet SB may be subject to or may undergo induction heating operation/procedure, a procedure P₃ at which forging operation(s)/procedure(s) is performed to form the forged hammer head 114, a procedure P₄ at which the forged hammer head 114 may be subject to or may undergo a trimming operation/procedure, and a procedure P₅ at which the trimmed, forged hammer head 114 may be subject to or may undergo a shot blasting operation/procedure. The procedure of the method M may interchangeably referred to as a process or an operation.

At the procedure P₁, the steel billet SB is provided to a furnace (at which the steel billet SB may be subject to or may undergo heating). The steel billet SB may be made through continuous casting on a continuous castings machine (CCM). The steel billet SB may generally have a square, a round or a flat cross-sectional configuration. The cross-sectional configuration of the steel billet SB may be the same throughout the length of the steel billet SB and the length of the steel billet SB may be as per requirement hot cut while casting the steel billet SB. Billets made from other metal materials or metal alloy materials may be used. Choosing the volume and the dimensions of the steel billet SB may avoid under filling or excess filling.

At the procedure P₂, the steel billet SB, which is provided to the furnace at procedure P₁, may be heated. The steel billet SB may be subject to or may undergo the induction heating. The furnace may be an induction billet heating furnace that allows for the production of the billets ready for forging. The induction billet heating furnace may be used for heating steel billets. The induction billet heating furnace may heat the billet to temperatures ranging from room temperature to over 1500 degrees Fahrenheit (815° C.). The heating temperature may be controlled manually by the operator or automatically by a controller (including one or more processors and/or a temperature controller). The furnace may run continuously or may be set up to heat the billet to a specific temperature and then the billet is removed from the furnace. When the billet is placed in the furnace, the induction coil is powered up. The power to the coil is turned off when the billet is removed from the furnace. The steel billet may be heated using other heating procedures and/or other types of heating furnaces.

A plurality of billets may be heated together in the furnace and may be taken out after all of the heating process is completed. Therefore, although the heating process is completed using a target temperature, the billets may stand by in the furnace and is taken out from the furnace when a next procedure (e.g., forging) is available.

At the procedure P₃, the forging procedure is performed to form the forged hammer head 114.

Forging is a manufacturing procedure that involves the shaping of metal using localized compressive forces. The blows may be delivered either with a die or with a hammer (often a power hammer). Hot forging may generally refer to a process of generating a desired shape by pressing a billet heated at a high temperature, and may use the furnace as a facility for heating the billet.

During the forging procedure of the hammer head 114, the tool parting line TPL′ in the forging procedure is formed where the two forging dies (i.e., upper forging die UD and lower forging die LD) come together. A vestige of the tool parting line TPL′ may be formed on the hammer head 114. The vestige may be formed between the notch 191 and the top end TE of the hammer head 114. The selection of parting line (the line where two upper and lower forging dies UD and LD meet) may help ensure that the flow of material will be uniformly divided.

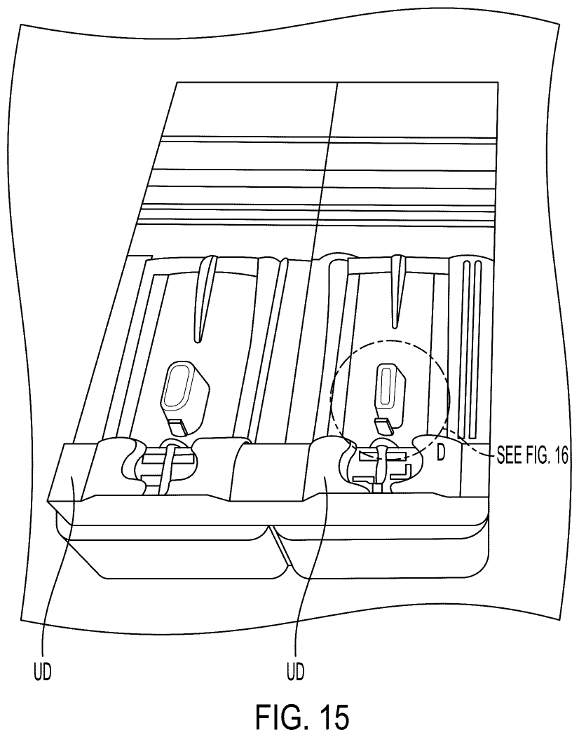

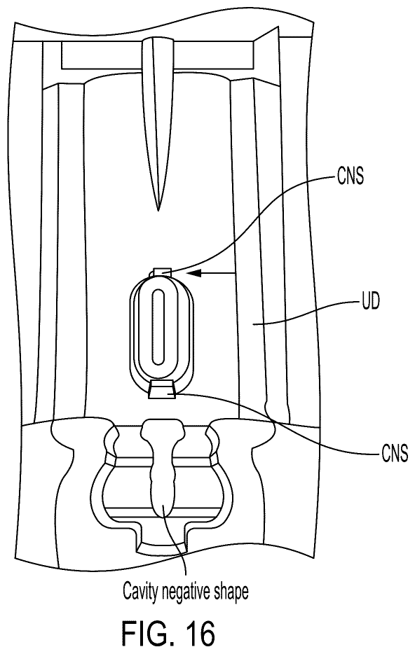

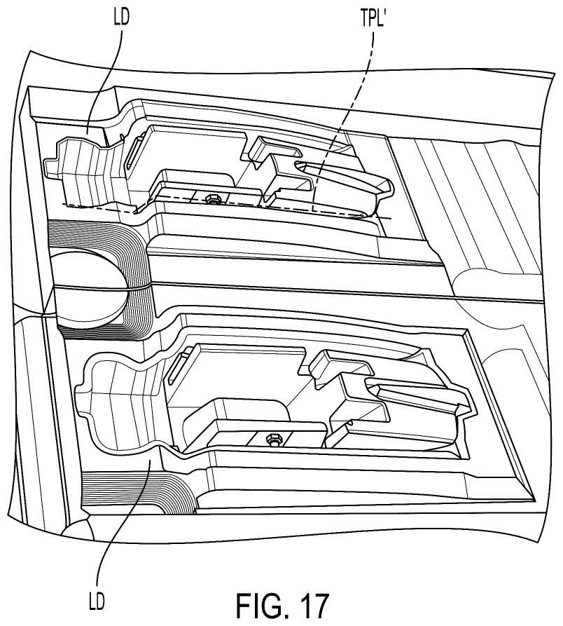

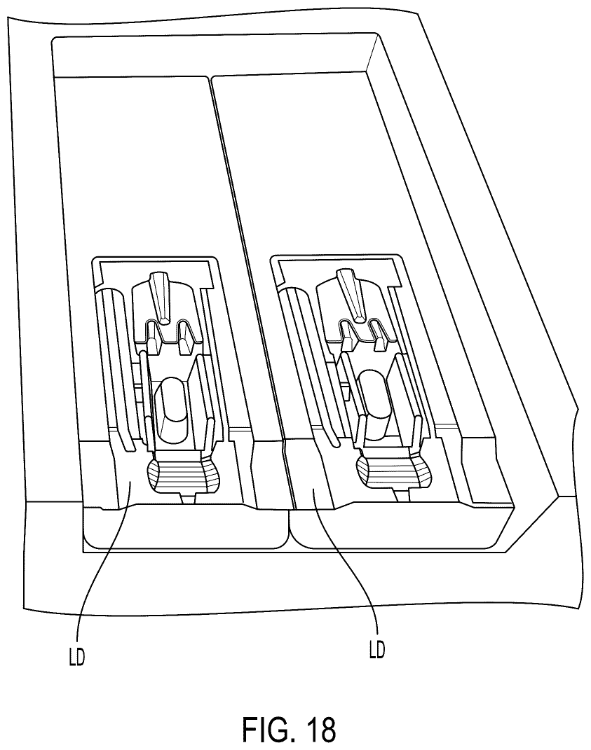

The upper forging die UD may interchangeably be referred to as top forging die, upper die, or top die. The lower forging die LD may interchangeably be referred to as bottom forcing die lower die, or bottom die. The two upper forging dies UD are shown in FIGS. 14-15. The tool parting lines TPL′ are also shown in FIGS. 14 and 17. The two upper forging dies UD are configured to cooperatively engage with two lower forging dies LD shown in FIGS. 17-18. FIG. 16 shows an enlarged view of portion D (shown in FIG. 15) and its surrounding portions of the upper forging die UD. Cavity negative spaces CNS of the cavities 197 are shown in FIG. 16. FIG. 18 shows an enlarged view of portion E (shown in FIG. 17) and its surrounding portions of the lower forging die LD. Side nail puller negative spaces SNPNS₁ and SNPNS₂ of the side nail pullers 145 and 185 are shown in FIG. 18.

The forging is a closed die forging in which the steel/metal billet is deformed in upper and lower forging dies UD and LD for desired shape and dimensions of the hammer head. Deformation occurs in the closed cavity (formed between the upper and the lower forging dies UD and LD) under high pressures, which achieves precision forgings with tight tolerances. The design of forgings dies UD and LD may also depend on the processing steps, the type of the billet material, flow stress, working temperature, etc. To obtain high precision, the upper and lower forging dies UD and LD may be machined by Computer Numeric Control (CNC).

The forged hammer head 114 may be implemented on the hammer handles that may be made of wood and made of fiberglass. The hammer head 114 of the present patent application is forged without complex and costly post process machining or casting process. The forged hammer head 114 with the integrated 180° side nail puller 145, 185. As shown in FIG. 7, the side nail puller 145 is located below the tool parting line TPL′ for the top and bottom forge dies. The shape of the side nail puller 145 is completely open at the bottom to allow the forging die to form the side nail puller.

Forging may be configured to provide a higher level of structural integrity than any other metal working processes/procedures. By eliminating structural voids that can weaken hammer head, forging may be configured to provide a level of uniformity to help maximize the performance of the hammer head. During machining, grain ends are exposed, making hammer heads more susceptible to weakening and cracking. By contrast, forging may be configured to refine and strengthen the hammer head by keeping the grain flow intact, helping to strengthen transition points and prevent premature failures. Forging may also offer uniformity of composition and structure. Forging may also result in metallurgical recrystallization and grain. The tight grain structure of forging may offer great wear resistance without the need to make hammer head harder than they are.

Forging is a form of metalworking that directly molds all of the metal that you use. Because forging requires less starting material to create the hammer head, forging may help reduce waste and material costs. With forging, the hammer head is shaped by the forging dies, significantly reducing material waste. Forging may be used to make number of/several replicas of the same molded piece of metal. The forged hammer head, referred in these discussions, includes the forged side nail puller.

In contrast to the prior art hammer shown and described in FIGS. 31A-36B and in the '432 Patent described in the background section, the forged hammer head of the present patent application is formed in the forging procedure, and the forged hammer head includes the forged side nail puller disposed between the forged hammer face and the forged hammer claw. As described in detail throughout the present patent application, the forged hammer head with the forged side nail puller has many advantages over these prior art hammers.

The 180 degrees side nail pullers 145, 185 are made during the forging procedure. The 180 degrees side nail pullers 145, 185 are functional features and the trimming operation do not affect them.

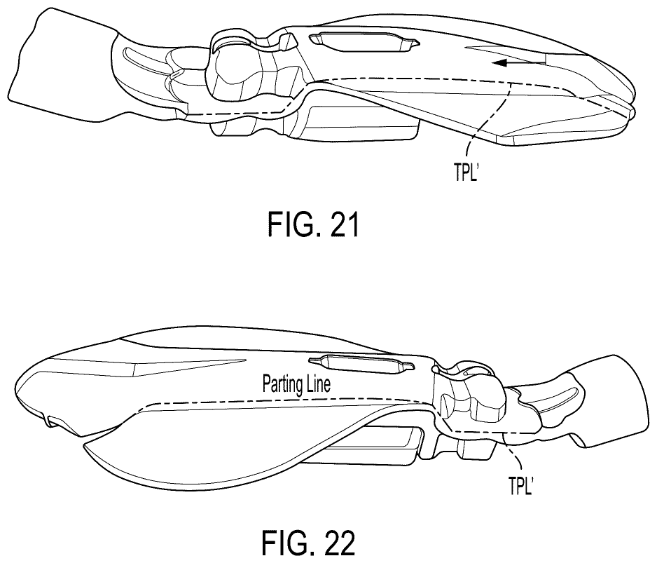

FIG. 21 shows an exemplary front perspective view of the forged hammer head 114, during the method for forming the forged hammer head (e.g., after forging procedure(s) and before trimming procedure). FIG. 22 shows an exemplary rear perspective view of the forged hammer head of FIG. 21. FIGS. 21-22 show the stepped configuration tool parting line TPL′ in both the front and the rear views.

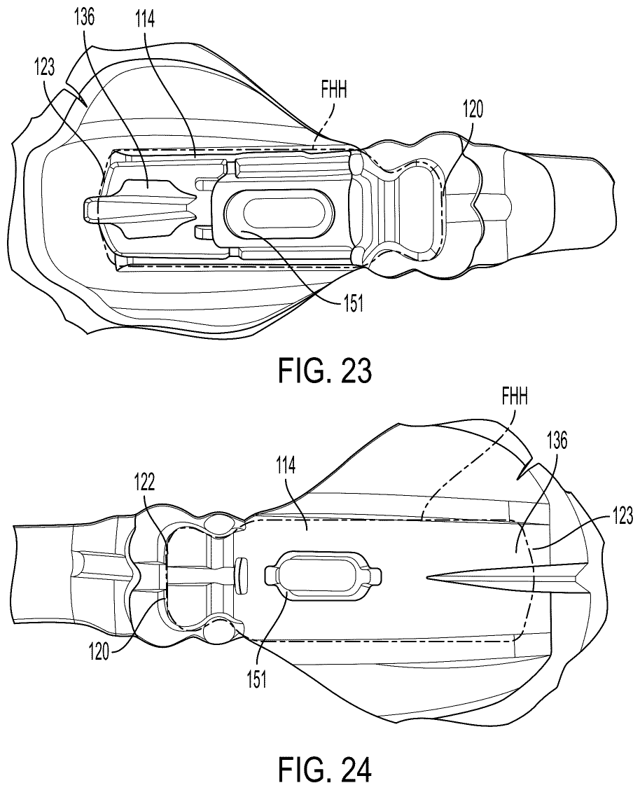

At the procedure P₄, the forged hammer head 114 may be subject to or may undergo a trimming procedure. The trimming procedure may be a manufacturing procedure that is used as a finishing procedure for the forged hammer head in order to remove flash (a characteristic common in most metal forgings). A trimming/trim press may generally be used in production lines directly after the forging procedure(s). The forged hammer head may be separated from its flash by the (high precision) trim press. The trim press may include rotary tables or standard tables for shearing, manually or automatically, flash or other portions of the forged hammer head. For example, referring to FIG. 23 (bottom view of the forged hammer head) and FIG. 24 (top view of the forged hammer head), only portions of the forged hammer head 144 that are within or inside the configuration profile/line “FHH” are removed by the trim tool/tooling/press. The trimming procedure may be a manual trimming procedure. The trimming procedure may be automatically performed by a controller (including one or more processors). The trim press may also be used for perforating operations, for example, the eye-hole 151 in the forged hammer head 114.

The trimming procedure may include pressing the forged hammer head through a cutting die that runs the periphery of the forged hammer head. The cutting die may be precisely designed to remove the flash from the forged hammer head. The trimming procedure may be performed while the forged hammer head is still hot. In other embodiments, the flash of the forged hammer head may also be ground or cut off using different methods. The trimming procedure may be optional.

At the procedure P₅, the trimmed, forged hammer head 114 may be subject to or may undergo a shot blasting procedure. After the forging and the trimming procedures, surface(s) of the trimmed, forged hammer head (including the hammer face, the hammer claw, and one or more side nail pullers and/or staple pullers) may be subject to the shot blasting procedure. The shot blasting is a mechanical procedure to remove any debris or any irregularities from a surface of the trimmed, forged hammer head. The shot blasting procedure may be a resurfacing process that is used to remove any debris or any irregularities from the surface of the trimmed, forged hammer head. The shot blasting procedure may use a centrifugal blast wheel that shoots media, which varies from steel shot to cut wire to nut shells, onto the surface at high velocity. This knocks the surface free of debris, irregularities or other materials from the surface of the trimmed, forged hammer head. The media loads into a hopper that feeds the blast wheel. The media may blast off debris, irregularities or other materials from the surface of the trimmer, forged hammer head. The shot blasting procedure may be performed after the trimming procedure. The shot blasting procedure may be optional. The shot blasting procedure may be replaced by other such procedures as would be appreciated by a person of ordinary skill in the art.

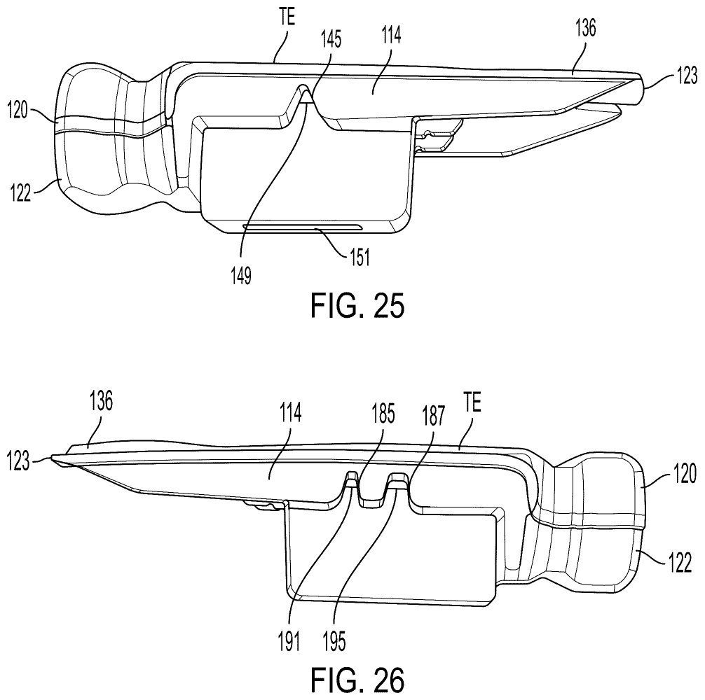

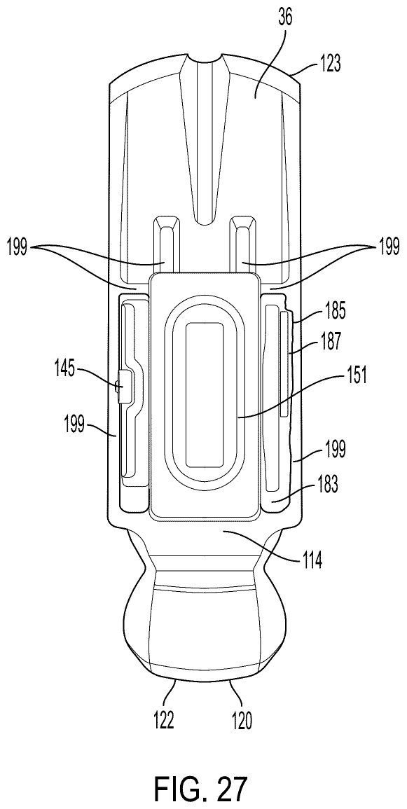

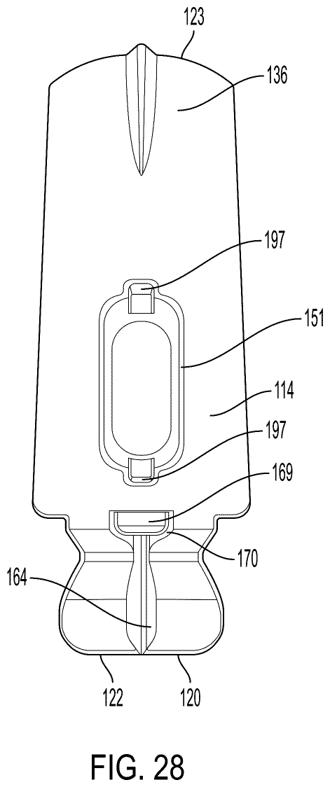

FIG. 25 shows an exemplary front view of the forged hammer head, after the trimming and shot blasting procedures, while FIG. 26 shows an exemplary rear view of the forged hammer head of FIG. 25, FIG. 27 shows an exemplary bottom view of the forged hammer head of FIG. 25 and FIG. 28 shows an exemplary top view of the forged hammer head of FIG. 25. Features such as the cavities 197, the eye-hole 151, the claw 136, the v-notch 138 and the walls of the forged hammer head 114 are all well-defined after shot blasting.

Example embodiments have been provided so that this disclosure will be thorough, and to fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In one embodiment, dimensions/numerical ratios or ranges of the present patent application may be up to 5 percent, 10 percent, 15 percent or 20 percent greater than or up to 5 percent, 10 percent, 15 percent or 20 percent less than the values described throughout the present patent application. In another embodiment, dimensions/numerical ratios or ranges of the present patent application may be in the range of +/−5 percent or +/−10 percent of the values described throughout the present patent application.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

Numerous modifications may be made to the exemplary implementations described above. These and other implementations are within the scope of this application.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

What is claimed is:

1. A forged hammer head formed in a forging process, comprising:
a forged hammer face at one end of the head;
a forged hammer claw at an end of the head opposite the face; and
a forged side nail puller disposed between the face and the claw, the side nail puller configured to engage and pull a nail from a workpiece, the side nail puller comprising a side wall and a notch formed in the side wall,
wherein a tool parting line of the forging process does not intersect the notch.

2. The forged hammer head of claim 1, wherein the hammer head is formed as part of a two-piece hammer.

3. The forged hammer head of claim 2, wherein the hammer head comprises an eye-hole extending therethrough for receiving a hammer handle.

4. The forged hammer head of claim 3, wherein the hammer head is devoid of any structure between the notch and the eye-hole.

5. The forged hammer head of claim 1, wherein a vestige of the tool parting line is formed on the hammer head.

6. The forged hammer head of claim 5, wherein the vestige is formed between the notch and a top end of the hammer head.

7. The forged hammer head of claim 1, wherein the hammer head is formed as part of a one-piece hammer, and
wherein the hammer head is integrally formed as part of the same forging process as a hammer handle shaft.

8. The forged hammer head of claim 1, wherein the notch is perpendicular to the tool parting line.

9. The forged hammer head of claim 1, wherein the forged side nail puller is on one side of the hammer head,
wherein the forged hammer head further comprises a second forged side nail puller that is disposed on an opposing side of the hammer head.

10. The forged hammer head of claim 1, wherein the forged side nail puller is one of the plurality of forged side nail pullers.

11. The forged hammer head of claim 1, wherein the tool parting line of the forging process is above the notch.

12. A method for forming a hammer head, comprising:
sequentially placing a blank in a series of cooperating forging dies; and
sequentially shaping the blank in the forging dies into a hammer head, a hammer claw, a hammer face, and a side nail puller disposed between the face and the claw, the side nail puller comprising a side wall and a notch formed in the side wall,
wherein the hammer head is configured to be coupled to or formed with a handle shaft, and
wherein the notch extends generally parallel to an axis of elongation for the handle shaft.

13. The method of claim 12, wherein the forging dies comprise at least two die portions,
wherein a tool parting line is formed at an interface of the die portions, and
wherein the tool parting line is formed such that the tool parting line does not intersect the notch.

14. A forged hammer head for a two-piece hammer, the hammer head formed in a forging process, comprising:
a forged hammer face at one end of the head;
a forged hammer claw at an end of the head opposite the face; and
a forged side nail puller disposed between the face and the claw, the side nail puller configured to engage and pull a nail from a workpiece, the side nail puller comprising a side wall and a notch formed in the side wall,
wherein the head has an eye-hole extending therethrough for receiving a hammer handle, and
wherein the hammer head is devoid of any structure between the notch and the eye-hole.

15. The forged hammer head of claim 14, wherein the forged hammer head is formed in a forging process,
wherein a tool parting line of the forging process does not intersect the notch.

16. The forged hammer head of claim 15, wherein a vestige of the tool parting line is formed on the hammer head,
wherein the vestige is formed between the notch and a top end of the hammer head.

17. The forged hammer head of claim 14, wherein the notch is perpendicular to the tool parting line.

18. The forged hammer head of claim 14, wherein the forged side nail puller is on one side of the hammer head,
wherein the forged hammer head further comprises a second forged side nail puller that is disposed on an opposing side of the hammer head.

19. The forged hammer head of claim 14, wherein the forged side nail puller is one of the plurality of forged side nail pullers.

20. The forged hammer head of claim 1, wherein the tool parting line of the forging process is above the notch.
